(19) United States
(12) Patent Application Publication
(10) Pub. No.: US 2016/0314856 A1
(43) Pub. Date: Oct. 27, 2016

(54) SPONTANEOUS ALPHA PARTICLE EMITTING METAL ALLOYS AND METHOD FOR REACTION OF DEUTERIDES

(71) Applicant: Douglas Arthur Pinnow, Lake Elsinore, CA (US)

(72) Inventor: Douglas Arthur Pinnow, Lake Elsinore, CA (US)

(21) Appl. No.: 14/696,423

(22) Filed: Apr. 25, 2015

(51) Int. Cl. G21B 1/11

(52) U.S. Cl. CPC G21B 1/11

(57) ABSTRACT

This invention describes materials and apparatuses suitable for triggering a low energy nuclear reaction of deuterium nuclei in a metal alloy consisting of a host metal, such as palladium, and a second metal that spontaneously emits alpha particles, such as thorium, with a sufficient concentration to have at least one alpha particle emission, on average, per minute in each cubic centimeter of metal alloy.

### CROSS REFERENCES TO RELATED APPLICATIONS

This application claims the benefit of U.S. Provisional Patent Application Ser. No. 61/996,097 filed Apr. 29, 2014, titled APPARATUS AND METHOD FOR INTERMEDIATE ENERGY REACTION OF DEUTERIUM TRIGGERED BY SPONTANEOUS RADIOACTIVE DECAY, the contents of which are hereby incorporated by reference herein.

### FIELD OF THE INVENTION

This invention describes materials and apparatuses suitable for triggering a low energy nuclear reaction of deuterium nuclei in a metal alloy consisting of a host metal, such as palladium, and a second metal that spontaneously emits alpha particles, such as thorium, with a sufficient concentration to have at least one alpha particle emission, on average, per minute in each cubic centimeter of metal alloy.

### BACKGROUND OF THE INVENTION

1. Overview

The following is an informative perspective on the field of low energy nuclear reactions (LENRs) that has been extracted from an Unclassified U.S. Government Report prepared by the Defense Intelligence Agency (DIA-08-0911-003) dated Nov. 13, 2009 titled ‘Technology Forecast: Worldwide Research on Low-Energy Nuclear Reactions Increasing and Gaining Acceptance’:

“In 1989, Martin Fleischmann and Stanley Pons [both chemistry professors at the University of Utah] announced that their electrochemical experiments had produced excess energy under standard temperature and pressure conditions. Because they could not explain this physical phenomenon based on known chemical reactions, they suggested that the excess heat could be nuclear in origin. However, their experiments did not show the radiation or radioactivity expected from a nuclear reaction. Many researchers attempted to replicate the results and failed. As a result, [a substantial portion of] the physics community disparaged their work as lacking credibility, and the press mistakenly dubbed it ‘cold fusion’. Related research also suffered from the negative publicity of cold fusion for the past 20 years [as of the 2009 date of this DIA Report], but many scientists believed something important was occurring and continued their research with little or no visibility.

For years, scientists were intrigued by the possibility of producing large amounts of clean energy through low energy nuclear reactions (LENR), and now this research has begun to be accepted in the scientific community as reproducible and legitimate.

Scientists worldwide have been quietly investigating low-energy nuclear reactions for the past 20 years. Researchers in this controversial field are now claiming paradigm-shifting results, including generation of large amounts of excess heat, nuclear activity and transmutation of elements. Although no current theory exists to explain all the reported phenomena, some scientists now believe quantum-level nuclear reactions may be occurring. DIA assesses with high confidence that if LENR can produce nuclear-origin energy at room temperatures, this disruptive technology could revolutionize energy production and storage, since nuclear reactions release millions of times more energy per unit mass than do any known chemical fuel.

Although much skepticism remains, LENR programs are receiving increased support worldwide, including state sponsorship and funding from major corporations. DIA assesses that Japan and Italy are leaders in the field, although Russia, China, Israel, and India are devoting significant resources to this work in the hope of finding a new clean energy source. Scientists worldwide have been reporting anomalous excess heat production [for years], as well as evidence of nuclear particles and transmutation.”

Of the numerous reports and publications that summarize recent progress in this field, one stands out as being particularly informative. The highly respected authors are Peter L. Hagelstein (MIT), Michael C. H. McKubre (SRI International), David J. Nagel (The George Washington University), Talbot A. Chubb (Research Systems), and Randall J. Heckman (Heckman Industries) and their report is titled NEW PHYSICAL EFFECTS IN METAL DEUTERIDES, U.S. Department of Energy LENR Review (2004). They conclude that “the experimental evidence for anomalies in metal deuterides, including excess heat and nuclear emissions, suggests the existence of new physical effects.”

Clearly, if these “new physical effects” could be understood sufficiently to control low energy nuclear reactions that could produce useful amounts of energy, this would have a major impact on civilization, especially if these reactions require very little radiation shielding to protect humans.

2. Description of Related Art

During the 26 years since Pons and Fleischmann announced their experimental results in 1989 that they thought might be attributed to some unexplained nuclear reaction, there have been many attempts to duplicate their work with varying degrees of success and mostly failure. Unfortunately for Pons and Fleischmann, no viable theory had emerged that could explain the five major objections to attributing Pons and Fleischmann's reported results to a nuclear reaction or multiple reactions. They are:
1. The Seeming Impossibility of Nuclear Fusion Reactions Occurring at Room Temperature,
2. Little or No Neutron Radiation (as would be expected based on hot fusion of deuterium),
3. Little or No Observed Fusion By-products (as would be expected based on hot fusion of deuterium),
4. Lack of Repeatability of the Process, and
5. No Known Way to Control the Process to Produce and Change Output Power Levels on Demand

Before continuing, it should be noted that due to the controversial nature of Pon's and Fleishman's work, the subsequent publication of related results in traditional refereed scientific and engineering journals has been stilted and much of the relevant early work in this field was covered by reputable newspapers and new magazines, including the Wall Street Journal, the Los Angeles Times, and TIMES magazine, in view of the broad interest in this story and the huge financial implications. This comment is to explain why the following discussion draws, in part, upon these non-traditional resources for scientific and engineering information.

The following is an old but succinct description of the Pons and Fleischmann experiment by Jerry E. Bishop (Staff Reporter for The Wall Street Journal) in his Feb. 7, 1991 article: “The much publicized ‘cold fusion’ experiment applies an electric current to a palladium metal rod [cathode] and an encircling platinum wire [anode] that are immersed in a laboratory bottle of ‘heavy’ water. The apparatus is essentially an electrolysis-of-water ‘cell’ common in high school chemistry classrooms, except that the electrodes are precious metals and the electrolyte is heavy water, in which the hydrogen atoms are the doubly heavy kind known as deuterium [D]. The controversy rages over claims that the fusion of deuterium atoms inside the palladium rod releases excess energy.”

And although this was written in 1991, the controversy continues to the present with the USPTO taking the majority position by siding with the skeptics. Specifically, the USPTO has included ‘cold fusion’ in the same category as a perpetual motion machine (see MPEP 2107.01) which cannot be patented because the underlying concept is incredible or speculative. The present inventor agrees with this position because the claim of a fusion reaction involving deuterium at or around ambient (room) temperature would not be believable by any person of normal knowledge or skill in the science and/or technology of nuclear reactions.

Nevertheless, the amount of energy released by a hydrogen bomb is a testimony that fusion reactions are capable of producing immense amounts of energy when hydrogen nuclei react. And many governments, including the U.S. Government, have supported ‘hot fusion’ programs using ionized gas plasma reactors and laser beam compression of small fuel pellets for decades to tame the hydrogen fusion reaction with a goal to produce controllable fusion energy to supplement or replace the burning of fossil fuels. While incremental progress has been made, it is fair to say that this work, with over a 40 billion dollar investment to date, has not yet reached the “break even point” where the energy output from any hot fusion reactor has equaled or exceeded its energy input.

The reason that some of the ‘hot fusion’ reactors employ ionized gas plasmas is because it is well known that the hydrogen ions (typically ions of hydrogen isotopes of deuterium, D, having one proton and one neutron, and/or tritium, T, with one proton and two neutrons) must “crash” into one another to cause a fusion reaction. The high temperature plasma environment provides these randomly moving hydrogen ions (nuclei) sufficient kinetic energy of motion to overcome the natural repulsive forces between ions due to the positive electrical charges carried by their protons. The electrical repulsion of two such charges is often referred to as ‘Coulomb repulsion’ or being caused by the electrostatic ‘Coulomb barrier’. In order for a hot fusion reaction to occur, plasma temperatures must be in the range of 100 million degrees Centigrade or higher! And for “break even”, a very high density and high temperature of hydrogen (deuterium and/or tritium) ions must be sustained for a sufficiently long time so that many crashing fusion reactions can occur. These extremely demanding conditions have led to many technological problems related to plasma instabilities that have precluded early success with the ‘hot fusion’ approach. In view of the difficulties encountered, Government support has also been made available for the alternative ‘hot fusion’ approach using multiple focused laser beams to compress and heat small fuel pellets containing deuterium and tritium.

Nevertheless, it is all too well understood by scientists working in the field of hot fusion that a temperature in the range of 100 million degrees and above is necessary to initiate a hot hydrogen fusion reaction. This leads directly to the first objection, above:
1. The Seeming Impossibility of Nuclear Fusion Reactions Occurring at Room Temperature.

And it has been well known and well documented for decades that hot fusion of, say, two deuterium (D) ions proceeds almost entirely by one of the following two reactions:

D+D→⁴He)*→T+proton+(Energy of 4.0 MeV) (1)

or

D+D→(⁴He)*→³He+neutron+(Energy of 3.3 MeV) (2)

with about equal probabilities for occurrence (about 50% probability for each reaction). In both Equations (1) and (2), above, the intermediate reaction product (⁴He)* represents and excited state of the helium nucleus [the “*” implies an excited state and the superscript “⁴” refers to an atomic weight of 4 units corresponding to two proton and two neutrons for helium] and the ‘Energy’ on the right hand side of both equations is equated to the sum of the kinetic energies of the reaction by-products—the T (tritium which is an isotope of hydrogen with one proton and two neutrons) and proton in the first equation and the ³He and neutron in the second equation.

The fortunate thing about the first reaction above is that both the energetic T and proton by-products (both having electrical charges) are stopped after traveling only a very short distance in a solid material. They can even be stopped by a sheet of paper or a metal foil. But, this is not so for the neutron (having no electrical charge) in the second reaction. The neutron by-product of hot fusion is a highly penetrating form or radiation that requires substantial shielding to protect humans. Significantly, neutron radiation detectors have been well developed for monitoring uranium fission reactors and hot hydrogen fusion reactors. Yet, when these same radiation detectors have been used to monitor low energy nuclear reactions they have not yet measured any substantial neutron radiation! That leads directly to the second objection:
2. No Neutron Radiation (as would be Expected Based on Hot Fusion of Deuterium).

Finally, the tritium (T) reaction by-product in Equation (1), above, is known to be radioactive with a half-life of 12.26 years, and its presence can be easily discerned by detecting the beta ray it emits when it decays to a helium isotope (³He) by beta emission. This is the source of the third objection:
3. Little or No Observed Fusion By-products (as would be expected based on hot fusion of deuterium)

There was an interesting article in the Apr. 3, 1990 issue of the Wall Street Journal (WSJ) reporting that attempts had been made at 25 different laboratories to repeat Pons and Fleischmann's results with a total of 40 reactor cells showing some anomalous extra thermal (heat) output. However, the article by Jerry E. Bishop (WSJ Staff Reporter) went on to say: “The cold-fusion researchers conceded their biggest problem is that they still cannot turn their experiments on and off at will. The experiments turn on [if they turn on at all] at completely unpredictable times and no one yet has figured out what triggers them.” This leads directly to Objections 4 and 5:
4. Lack of Repeatability of the Process, and
5. No Known Way to Control the Process to Produce and Change Output Power Levels on Demand

Actually, Objections 4 and 5 may be considered a source of encouragement for some scientists because these objections appear to acknowledge that an actual (real) process is taking place but that the process is not understood sufficiently well to be controlled. The following quote from a subsequent 1991 article by Jerry E. Bishop (WSJ Staff Reporter) adds some human interest to the inexplicable results:

“. . . a dozen labs also reported measuring ‘excess’ heat from similar [to Pons and Fleischmann's] electrolytic experiments, although amounts of such heat vary widely. One of the reports . . . was given by Richard A Oriani, professor of chemical engineering at the University of Minnesota.

Mr. Oriani said his skepticism of the Utah claims [by Pons and Fleischmann] was initially confirmed when his first experiments last spring failed to produce results. But he then borrowed a palladium rod from chemists at Texas A&M who said that they were getting excess heat. ‘The Results were fascinating,’ he said. On the fourth ‘run’ with the borrowed rod, the experiment began producing excess heat. The experiment was stopped briefly to change an instrument. When it was restarted, heat output ‘really took off’ and produced excess heat for several hours before dying down, he said.

Typical of other experiments, Mr. Oriani said his experiment was ‘very erratic.’ It would go along doing nothing but dissociating the heavy water [in a Pons/Fleischmann reactor, as described, above] and then at totally unpredictable times, it would begin producing excess heat for as long as 10 to 11 hours before quieting down. The excess heat was 15% to 20% more than the energy involved in the electrolysis of water.

Mr. Oriani said the heat bursts were too large and too long to be explained by the sudden release of energy that might have slowly accumulated during the experiments' quiescent times, as some scientist have suggested. ‘There is a reality to the excess energy.’ He said.”

Clearly, if the totality of the results initially reported by Professors Pons and Fleischman and later confirmed by Professor Oriani and many others could be understood sufficiently well to produce useful amounts of energy, this could have a major impact on civilization, especially if the resulting apparatus required very little radiation shielding to protect humans.

### SUMMARY OF THE INVENTION

While numerous theories have been developed over the years to explain the results reported by Pons and Fleischmann, none have yet been broadly accepted by the scientific community and most have included one or more speculative concepts that have been likened by some to “miracles”. While one of more of these theories may ultimately turn out to be operative, the present work favors a ‘triggered reaction process’ introduced by the present inventor, Dr. Pinnow, that is fully consistent with known physics as well as essentially all reported experimental results, including those discussed, above, related to Pons and Fleischmann's pioneering work. As such, the triggered reaction process cannot be dismissed by a person of normal skill in the art as being speculative since it comports with established physics. At worst, it may be criticized for not yet being proven to be the dominant process that occurs in a Pons-Fleischmann reactor. However, for the purpose of this discussion, the triggered reaction process will be used as exemplary. However, one should realize that other reaction processes may also occur.

The words ‘low energy nuclear reaction’ have been chosen by many in the scientific community to describe a reaction process that may occur at effective temperatures at or well above room temperature (room temperature is normally associated with ‘cold fusion’) yet well below the much higher temperatures associated with ‘hot fusion’ that have been observed in plasma fusion reactors and in the production of power from the sun. The specific inventive aspect of this work goes on to explain a method for consistently initiating and possibly sustaining the reaction process using alpha particle emitting metal atoms purposely disbursed in the palladium (or some other) host material. These alpha particle emitting atoms serve to trigger the reaction, as will be described.

After studying the experimental results relating to the Pons and Flesichmann experiment and all subsequent related work over the past 26 years, the present inventor has concluded that the excess heat that has been observed is likely due to a form of low energy nuclear reaction but not ‘cold fusion’. In fact, he has concluded that the reaction process proceeds at much higher temperatures, in the range of one million degrees Centigrade and above!

At first, this might seem to be just another incredible assertion that would require a “miracle” since everyone associated with Pons and Fleischmann's work knows that the process they observed took place in a container that, in most cases, didn't even reach the boiling point (101.6 degrees Centigrade) of the heavy water within.

But, the apparent contradiction, above, has been resolved by Dr. Pinnow's insight, gained from years of experience in the nuclear power industry. He realized that if a nuclear reaction (either fission or fusion) took place in a metal material, like uranium or palladium, the energetic reaction products would heat the submicroscopic region where the reaction took place to an immensely high temperature. This result is well known and is called a ‘thermal spikes’. Such thermal spikes are caused by the energetic subatomic particles, such as fusion by-products, naturally occurring radioactive decay by-products, or even cosmic rays. Thermal spikes are well known to occur in fuel elements used in uranium fission reactors and the pioneering work relating to the understanding these effects are well covered by the 1963 Nobel Prize winner, Eugene Paul Wigner and his associate, Fredric Seitz, in their 1956 paper titled “Effects of Radiation on Solids” that was reprinted in 2015 by SCIENTIFIC AMERICAN in a Special Commemorative Edition dedicated to Nobel Prize winners (SCANOBEL15). In fission reactor fuel elements, a localized thermal spike occurs in the immediate vicinity of a uranium atom that undergoes nuclear fission. The very high kinetic energies of the fission by-product nuclei are transferred to several thousand nearby atoms causing an extremely localized ‘thermal spike’ that persists for a very brief period, less than a nanosecond. While it is recognized that such thermal spikes can cause highly localized melting and re-solidification, the actual temperature associated with such spikes is seldom, if ever, discussed in relation to fission reactors for two reasons. First, on the practical side, the temperature reached by a thermal spike is not particularly relevant to the design or operation of a fission reactor. But, at a more basic or theoretical level, the concept of ‘temperature’ is only well defined when thermodynamic equilibrium persists. And these thermal spikes occur so quickly, both during heating and cooling, making it unlikely that thermodynamic equilibrium is fully established. For example, the palladium ions, the deuterium ions, and the electrons within a thermal spike may all have different statistical energy distributions corresponding to different temperatures. Nevertheless, an approximate estimate of some sort of ‘effective temperature’ within a thermal spike serves as a useful way to distinguish it from ‘cold’ or ‘ambient’ conditions that have led some scientists to draw an erroneous conclusion regarding the prospects for the occurrence of ‘cold fusion’.

In fission reactors, the occurrence of thermal spikes is well known and easily recognized by an observed slow swelling of the outside dimensions of uranium fission reactor fuel elements. Each thermal spike briefly melts a very localized (microscopic) section of the atomic host lattice within the fuel element. And because the cooling of the spikes occurs so rapidly, high temperature lattice defects (such as micro-voids and other defects) are frozen in place. The net effect is that as more and more voids and defects build up in fuel rods during the operating life of a fission reactor, swelling occurs and must be dealt with in the design of the fuel elements to ensure that narrow cooling passages, for example, between fuel plates are not compromised. Otherwise, melting of a macroscopic portion of a fuel element could occur that would release harmful radioactive materials throughout the interior of a fission reactor that would be difficult to remove and could be harmful to any humans working near the reactor.

As mentioned, the actual temperature of a thermal spike is not particularly significant to the operation of fission reactors. Yet, it is possible to estimate their magnitude, based on analysis of the cosmic rays that occasionally pass through metals like uranium fuel elements and the palladium rods used by Pons and Fleischmann. The results show that approximately several thousand nearby atoms are heated to have kinetic energies of approximately 100 eV (electron Volts) each. And since room temperature (20 degrees Centigrade or 293 degrees Kelvin) corresponds to 1/40 eV, the ‘effective temperature’ of the atoms nearby a thermal spike would be approximately 100 eV/( 1/40 eV)×293 degreed Kelvin=1,172,000 degrees Kelvin or approximately 1.2 million degrees Centigrade (C)!

While a million plus degrees C. is impressively high and certainly not ‘cold’ as the words ‘cold fusion’ would suggest, it is still insufficient (judged on the basis of ‘effective temperature’ or average kinetic energy of the deuterium nuclei) to penetrate or overcome the electrostatic Coulomb potential barrier to cause an effect similar to hot fusion. (Recall that it was mentioned, above, that hot fusion required a temperature in the range of 100 million degrees C.)

However, a million degrees C. should be sufficient for the interacting nucleons to penetrate this barrier by a well-known process first described by the famous physicist, Robert Oppenheimer, who headed the Manhattan Project during the Second World War, and his associate, Melba Phillips. They had been particularly interested in nuclear reactions that appeared to penetrate through a Coulomb barrier. Here is what Professor Robert Leighton from the California Institute of Technology had to say about the Oppenheimer-Phillips process in his highly regarded text PRINCIPLES OF MODERN PHYSICS (McGraw Hill Book Company, New York, 1959): “. . . (D, proton) reactions [such as Equation (1), above] are much more commonly observed than would be expected . . . The reason for this was deduced by Oppenheimer and Phillips (1935). When a deuteron [D] approaches a nucleus [either another deuteron or some other nucleus], the repulsion between the nucleus and the proton causes the deuteron to become polarized with its proton farther from the nucleus. The proton-neutron bond distance for the deuteron is of such a size (−5×10⁻¹⁵ m) that the neutron can be inside the nucleus before the proton has surmounted the Coulomb barrier. The weak bond (2 MeV) of the deuteron is easily broken, so that the proton can be ejected and the neutron retained.”

With the benefit of this knowledge, it is important to realize that the (D, proton) reaction, similar to that in Equation (1), would be much more likely to occur than the (D, neutron) reaction in Equation (2) at temperatures below hot fusion temperatures since the later would require the electrically charged proton to penetrate or overcome the Coulomb barrier. Even with the possibility of quantum mechanical tunneling, proton penetration to cause a fusion reaction would be very improbable. It is, in fact, quite plausible that the nuclear reaction that takes place in Equation (1) would avoid the intermediate step of forming an energetic helium nuclei (⁴He)* because the proton would be ejected before it could penetrate the Coulomb barrier. In this case, Equation (1) can be simply rewritten as:

D+D→T+proton+(Energy of 4.0 MeV) (1a).

The Oppenheimer-Phillips process is very significant because it can explain why Equation (1) or (1a) is highly favored for low energy nuclear reactions (LENRs) and why Equation (2) is not. This not only explains why Pons and Fleischman and other who followed them did not observe any substantial neutron emissions. It is also very fortunate, indeed, because most or all of the neutrons produced by Equation (2) during hot fusion are eliminated along with the need for substantial radiation shielding. Significantly, this has been observed to be the case in all of the experimental results preformed to duplicate Pons and Fleischmann's results.

It should be included here that one of the most vociferous objectors to cold fusion, John Huizenga, mentioned the Oppenheimer-Phillips process in his book “Cold Fusion: The Scientific Fiasco of the Century” (Oxford University Press, Oxford & New York, 1993 pages 75-76 and page 125). While Huizenga correctly rejected the possibility that this mechanism could have any substantial effect on a fusion process at ambient (room) temperature, he badly missed the bigger picture by neglecting to consider the much higher temperatures within a thermal spike where the Oppenheimer-Phillips process can becomes a significant factor.

While the precise shape of the Coulomb barrier can be easily calculated in a vacuum environment, this is not possible within a metal host such as palladium. The analytical complication is due to the fact that both free electrons in the metal as well as electrons that may be bound to palladium nuclei all play a part in ‘screening’ the protons in deuterium from ‘seeing’ or experiencing the full force of each other during a close encounter. This screening effect is difficult to analyze, but it always serves to reduce the effective width of the Coulomb barrier, making intermediate energy nuclear reactions more probable. In situations like this, it is helpful to complement difficult analyses with experimental results. That is just what J. Kasaki et al reported doing in their 1998 paper titled ANOMOUSLY ENHANCED D(d,p)T REACTIONS IN Pd AND PdO OBSERVED AT VERY LOW BOMBARDING ENERGIES (presented at the Seventh International Conference on Cold Fusion held in Vancouver, Canada). These researchers bombarded a palladium foil charged with deuterium with an external ion beam also of deuterium that could be varied in energy. They reported surprisingly large enhancements in the fusion reaction yield over what was expected based on simple analysis that did not include the effects of screening.

So, if Equation (1a) correctly describes the operative reaction pathway at low energies associated with Oppenheimer-Phillips reactions that are further enhanced by electron screening effects, why is the other reaction by-product of Equation 1(a), tritium (T), not observed at concentration levels consistent with the excess energies that have been reported to have been produced with Pons-Fleischmann electrolytic cells?

The answer to this question is not yet known for certain. But, one possibility is that a subsequent nuclear reaction with deuterium could ‘burn up’ most of the tritium by another Oppenheimer-Phillips type of reaction that again favors the emission of another proton, as follows:

D+T→(⁴H)*+proton+Energy (3)

where (⁴H)* stands for an excited state of a heavy isotope of hydrogen that has four nucleons, one proton and three neutrons.

Relatively little is known about this isotope. However, in the spirit of assigning names to the hydrogen isotopes like deuterium for a hydrogen nucleus with two nucleons and tritium with three nucleons, the name ‘quadium’ has been given to ⁴H and was popularized by Hollywood in the movie based on Leonard Wibberlay's political satire, The Mouse That Roared (Thunder Mouth Press, N.Y. 1955). But, ‘quadium’ is not frequently used by the scientific community because so little is known about ⁴H that it does not yet deserve a familiar name.

Most of what is known about ⁴H has been summarized in the data base maintained by the Brookhaven National Laboratory (www.nnde.bnl.gov/nuda2/). There, it is discussed that ⁴H can have various isotopic spin values and that a value of 2, has been observed to decay into tritium (T) plus a neutron in an extremely short time, approximately 10⁻²³ seconds.

If such a decay process were to follow Equation (3), the neutron decay product would require heavy shielding and this result would be inconsistent with the observed experimental results (few or no neutrons observed). However, the Brookhaven National Laboratory data base also mentions other states of ⁴H having isotopic spins of 0 and 1 that have been analytically studied but not yet observed. These states are predicted to be more stable than the observed isotopic 2 state, mentioned above. And analysis has established that they undergo beta decay (the emission of an energetic electron from the nucleus) with various half-lives ranging from 0.03 seconds to greater than 10 minutes. If beta decay of the ⁴H isotope follows after the reaction in Equation (3), no shielding would be required because it is well known that beta particles would be quickly absorbed in the structure of a Pons-Fleischmann electrolytic cell. The spontaneous decay reaction following Equation (3) would be:

⁴H→⁴He+beta particle+Energy (4)

This is consistent with the known reported experimental results and unpublished theoretical results determined by the present inventor that has established that the isotopic spin 1 state has the greatest binding energy of the ⁴H energy states and the work at Brookhaven National Laboratory that has been determined by calculation that this isotope spontaneously decays by beta emission.

With careful experimentation, it should be possible to observe an increase in He concentration, indicated by Equation (4), as an LENR proceeds. In fact, there have been some reports to this effect. One of the most credible was covered by the Los Angeles Times in their article of Oct. 26, 1992 prepared by Leslie Helm (LA Times Staff Writer) titled “Japan Keeps Working on Cold Fusion: A senior researched at NTT now claims to have evidence of the controversial phenomenon”. The article went on to say that Eiichi Yamaguchi, a senior researcher at the highly respected research institution, Nippon Telephone & Telegraph stated that “We now have evidence of the reality of cold fusion.”

Quoting this article: “Yamaguchi said that when he placed a palladium rod soaked in deuterium gas in a vacuum chamber, passed a current through it and then heated it to 100 degrees Centigrade, the combination began to heat up even more and highly sensitive instruments in the chamber detected the presence of a newly created element—helium-4 [⁴He]. ‘Only nuclear fusion could have created the helium atoms,’ says Yamaguchi, who said he reproduced the experiment five times over a five-week period beginning in early August, each time with the same result.”

More recently Michael McKubre at the SRI Institute has reported (in the 2004 paper he co-authored that is cited in the Overview, above) not only observing ⁴He but correlating its production directly with the production of the heat. He also has reported that the amount of ⁴He produced is exactly what would be expected from the reactions in Equations (3) and (4). This is, indeed, compelling support for an explanation that involves low energy nuclear reactions.

In this regard, it is informative to reflect back to 1992 when Akito Takahashi, a physicist from the Osaka University in Japan, was one of the many early researches who claimed to have observed extraordinary heat producing reactions similar to Pons and Fleischmann He was highly criticized at a lecture he gave at the Massachusetts Institute of Technology (MIT) because the nuclear radiations from his experiment were only a tiny fraction of what they should be if known ‘hot hydrogen fusion’ reactions (Equations 1 and 2, above) were generating the excess heat that he observed. Since he had no explanation, it was reported in the Apr. 15, 1992 issue of the Wall Street Journal [article titled “Physicist to Report Cold Fusion Findings From Japan at MIT's Bastion of Skeptics” by Jacob M Schlesinger] that Professor Takahashi nevertheless stuck to his guns, saying “I will say what we observed. . . . That's the only thing that I can do.”

In retrospect, both Professor Takahashi's results and his firm conviction of their correctness are entirely consistent with and supportive of a LENR reaction and the role that the ⁴H isotope likely plays. And now, 23 years later many other researchers have confirmed his observations.

Having addressed Objections 1, 2, and 3, above, the discussion will shift to the two remaining objections:
4. Lack of Repeatability of the Process, and
5. No Known Way to Control the Process to Produce and Change Output Power Levels on Demand

If an intermediate energy nuclear reaction, as described above, requires high temperatures associated with a thermal spike to go forward, there is a basic question of how such a reaction could get started (or, equivalently, to be triggered). But, once started, it is apparent that the reaction by-products, known to have kinetic energies in the range of several MeVs (Million electron Volts), would be capable of creating additional thermal spikes so that the reaction could possibly proceed in a sequence or chain of thermal spike events.

Before discussing how an LENR might be triggered, it is instructive to review how typical uranium fission reactors are first started up since there are number of similarities. The following explanation is from Wikipedia (wiki/Nuclear reactor physics) is consistent with the inventor's knowledge: “The mere fact that an assembly [uranium fission reactor] is supercritical does not guarantee that it contains any free neutrons at all. At least one neutron is required to “strike” [or initiate] a chain reaction, and if the spontaneous fission rate is sufficiently low it may take a long time (in ²³⁵U reactors, as long as many minutes) before a chance neutron encounter starts a chain reaction even if the reactor is supercritical. Most nuclear reactors include a “starter” neutron source [trigger] that ensures there are always a few free neutrons in the reactor core, so that a chain reaction will begin immediately when the core is made critical. A common type of startup neutron source is a mixture of an alpha particle emitter such as ²⁴¹Am (americium −241) with a lightweight isotope such as ⁹Be (beryllium-9).”

While most modern fission reactors do employ a startup neutron source, as described in this Wikipedia article, some of the early reactor designs that the present inventor had worked with in the past did not. The initial startup of a fission reactor (circa 1963) without a neutron source was called a “blind startup” because the neutron detectors that were used to monitor the power output initially showed no measurable readings. In such cases, the startup procedure could be rather dramatic because there would always be a small statistical possibility that the reactor would ‘blow up’ as the control rods were pulled out of the reactor's core. But, the blind startup procedure was well designed to make the probability for a nuclear accident extremely unlikely. The startup was called a ‘pull and wait’ procedure because the control rods were pulled out of the reactor core by a small increment and then the operators would wait a predetermined time, typically, around 10 minutes, to see if some measureable level of neutrons could be observed on the neutron detectors. If there was no reading, the control rods would be pulled out of the core another small increment and another waiting period would follow. This step was repeated again and again until a measureable neutron level could be detected in the reactor core. From that point, the startup was no longer ‘blind’ and the power level would increase or decrease as the control rods were moved out or into the reactor core. The underlying principle behind this pull and wait procedure was to carefully avoid pulling out the control rods so far that the reactor would become super-critical before a chain reaction was initiated and sustained.

A little known fact is that during such blind startups there were two possibilities for creating the first free neutron that could initiate a chain reaction. The first possibility was well known. A uranium nucleus in the reactor core could spontaneously decay releasing a free neutron. The lesser known possibility is that one of the many cosmic rays that are known to bombard the earth could pass through the entire reactor superstructure and enter the core to trigger a uranium fission event. Scientific calculations actually determined that the probability for initiating the desired chain reaction during a blind startup of a new reactor was more likely due to a cosmic ray event than spontaneous fission of uranium.

With this background on the startup of fission reactors, one can better appreciate a possible explanation for why Observations 4 and 5 have been associated with fusion reactors of the type that Pons and Fleischmann had made. Importantly, there are no naturally occurring isotopes of the palladium rod material or in heavy water that could spontaneously decay to initiate some sort of nuclear chain reaction. So that a fully operational electrolytic cell (that might actually be a viable nuclear reactor) with a high concentration of D ions properly charged into a high purity palladium rod would still require some type of triggering event to produce the elevated temperature (thermal spike) necessary to initiate an Oppenheimer-Phillips nuclear reaction. Once a nuclear reaction was triggered, by any means, the energetic nuclear by-products shown in Equation (1a) could cause multiple secondary nuclear reactions to sustain a chain reaction.

The triggering candidate that immediately comes to mind is a cosmic ray event similar to those that often triggered the blind start-up in uranium fission reactors. But, there is one major difference between typical fission reactor and a Pons/Fleischman fusion reactor. Their volumes are vastly different—with fission reactors being typically 1 cubic meter while smaller fusion reactors are typically about 1 cubic centimeter. The ratio of these volumes is a million to one—and since size is approximately proportional to the likelihood of a cosmic ray event occurring within, one might have to wait only 10 minutes for a cosmic ray to randomly enter a fission reactor—but a million times longer for a fusion reactor (10 million minutes=19 years) in order to be highly certain that a reaction would be initiated. In reality, the palladium rod in an electrolytic cell may be several cubic centimeters and a reasonable (not highly probable) expectation time for a cosmic ray triggered reaction may be on the order of several months—as has been actually observed in multiple cases.

This provides a straight forward explanation why some attempts to repeat Pons and Fleishmann's experiments produced negative results. But, it doesn't explain why Pons and Fleischmann and others did succeed in some reasonable number of cases. Here, the inventor's experience in material science gained while working a Bell Labs becomes significant. He is aware that palladium, which is a precious metal, is seldom discarded after use due to its intrinsic value and that recycling is often accomplished in a laboratory by melting and casting it into an ingot or some other desired shape, such as a rod. Alternatively, palladium can be recycled by electrolytic refinement to eliminate impurities, a process usually done only by major suppliers.

When palladium is recycled by melting and reshaping, it requires rather high temperature processing due to its relatively high melting point of 1,555 degrees C. One common method is to melt the palladium in a platinum crucible (melting point of 1769 degrees C.) or, preferably, an iridium crucible (melting point of 2410 degrees C.) that is heated above the melting point of palladium in a radio frequency (RF) induction furnace. During this process, the crucible must be supported by some material that is electrically insulating (so that it will not directly absorb the RF energy), that can stand up at the high temperatures, and that has high thermal resistance so that it will not conduct a substantial amount of heat away from the crucible. One commonly used supporting material is a granulated form (called frit) of thorium dioxide (ThO₂) which is electrically insulating and has an exceptionally high melting point of 3050 degrees C.

While thorium dioxide is usually a satisfactory choice for such reprocessing, it is well known that small amounts of thorium may contaminate the palladium during recycling at a low level. This is significant, because 100% of naturally occurring thorium in nature is a single radioactive isotope, ²³²Th (or Th-232), that spontaneously emits energetic alpha particles with a long half-life of 1.4×10¹⁰ years each with an energy of 3.99 MeV (Million electron Volts). It is believed by the inventor that alpha particles from thorium atoms that may be within a palladium rod can serve as an effective triggering source that is responsible for the successful operation of some of the Pons-Fleischmann reactors. Basically, radioactive thorium contamination in palladium can provide more frequent triggering for the fusion reaction than is possible by cosmic rays alone.

Support for the assumption that the LENR is initiated by spontaneous radioactive decay of a radioactive ‘contaminant’ comes from various experimental efforts. Most notably, early experimental work performed at SRI International in Palo Alto, Calif. under the direction of Michael McKubre (1991) was quite consistently showing substantial excess heat production. And the SRI research team often used re-cycled palladium that may have been ‘contaminated’ by a radioactive triggering source during this process. It is also worth recalling the experience of Professor Oriani, discussed above. He was not able to observe any excess heat production until he borrowed some palladium rods from a group at Texas A & M that had had previous successes in producing excess heat—suggesting that these samples may also have been ‘contaminated’ by a triggering source since they responded much differently than the rods used by Professor Oriani in his earlier research.

To add further support to this possibility, there was an extremely embarrassing failure to produce excess heat after many attempts at the National Cold Fusion Institute that was formed at the University of Utah where Pons and Fleischmann had conducted their pioneering work. The director of this institute was keen on duplicating Pons and Fleischmann's results. However, he likely made a strategic mistake by insisting that the number of variables be reduced in the design and operation of the electrolytic test cells made at the Institute. One of the variables that he decided on eliminating was trace impurities in the palladium rods by always using only extremely high purity palladium. And none of the cells that were made at the National Cold Fusion Institute produced excess energy, even with the direct help and advice of Pons and Fleischmann! Following these negative results and lacking further funding, the Institute was eventually closed and ‘cold fusion’ was discredited by a majority of knowledgeable scientists. Pons and Fleischmann left the field in disgrace because they had no understanding of why their results were so irreproducible. And, until the present, the prevailing scientific view persists that ‘cold fusion’ was an unfortunate mistake. In fact, the principal mistakes were (1) to dub the reaction process ‘cold fusion’ when it is really occurring at quite high temperatures (in the range of 1.2 million degrees C. and, possibly, higher) and (2) to fail to realized that a triggering mechanism was required to initiate a chain reaction that could produce excess energy.

From the discussion, above, it would appear that the spontaneous alpha particle decay of thorium in a suitably high concentration within a palladium rod might serve as a useful triggering source to resolve the 4^{th} Objection:
4. Lack of Repeatability of the Process.

Of course, the concentration level of such a triggering source would have to be higher than the contamination levels that may have been achieved during casual reprocessing of palladium.

The following analysis supports the viability of thorium as a triggering source even though thorium has a very long half-life of 13.9 billion years (1.39×10¹⁰ years). While this may seem to be an excessively long time to wait for a decay that might possibly trigger a LENR, it is important to realize that there are 6.02×10²³ atoms (Avogadro's Number) of thorium in a single mole. So, there will be around 4.33×10¹³ alpha-particle decays every year in a mole of thorium (6.02×10²³ atoms divided by 1.39×10¹⁰ years). Or equivalently, 1.37 million (1.37×10⁶) such alpha particles decay every second per mole of thorium (4.33×10¹³ decays per year divided by 3.15×10⁷ seconds per year). And since thorium has a density of 11.7 grams per cubic centimeter and a mole of thorium weighs 232 grams there would be approximately 69,000 decays per cubic centimeter of thorium per second (1.37×10⁶ decays per second per mole divided by 232 grams per mole×11.7 grams per cubic centimeter) So, the addition of 1/69,000 (one part in 69,000) of a cubic centimeter of thorium to every cubic centimeter of palladium would result in one alpha-particle triggering event per second on average (in each cubic centimeter of palladium). Such a low level concentration of thorium should, indeed, serve as a reasonable triggering source so that long waiting periods are not required before an intermediate nuclear reaction would be initiated. In fact, even concentrations 60 times lower would result in one decay per cubic centimeter every minute or so. In some situations, this rate might be considered acceptable.

Due to the substantially shorter lifetime of radium (approximately 1620 years) for alpha-particle decay, a much low concentration of radium could be used to achieve a similar effect of about one triggering alpha-particle event per second per cubic centimeter. The kinetic energy released by this process is known to be 4.78 MeV (Million electron Volts). This is more than sufficient to cause a localized thermal spike in a host material, such as palladium, charged with a sufficiently high concentration of deuterium nuclei, that it could initiate a LENR. However, radium is substantially less common than thorium (with a total worldwide production of only about 5 pounds per year) and hence considerably more expensive.

There are a considerable number of possible spontaneously radioactive nuclides that could be used as trigger sources, including thorium and radium. Many of these sources emit alpha particles and have atomic numbers or 88 (corresponding to radium) or higher. Alpha emission sources are particularly desirable for triggering because the heavy alpha particles can create larger thermal spikes than, say, a lighter weight beta particle. However, most of these nuclides are quite rare and expensive. The only exception, other than thorium, is depleted uranium (²³⁸U) with an alpha particle decay life-time of 2.34×10⁷ years.

Nuclides that might decay by proton emission would also be reasonable candidates for triggering sources. However, nature does not provide any such proton emitters. The only other category of triggering sources that might be useful is spontaneous fission sources. These sources would have to be considered on a case-by-case basis because a substantial amount of fission energy could be lost to energetic neutrons that have long ranges and would not contribute their considerable energy to a localized thermal spike. Also the logistics involved with handling and transporting fissile nuclear materials represent a substantial complication.

Thus, thorium and depleted uranium are the preferred choices for elements to be added to palladium to serve as an alpha particle triggering source. Their addition could be made either individually or in combination since both elements are known to be fully soluble in palladium at the low concentration levels that have been calculated to be sufficient for effective triggering.

With the information disclosed above, the first four Objections to explaining Pons and Fleischmann's results as a LENR have been addressed and resolution appears plausible—although not assured.

If the first four Objections can be resolved with the use of a triggering source, as discussed above, the resolution of the final Objection:
5. No Known Way to Control the Process to Produce and Change Output Power Levels on Demand

becomes rather straight-forward but completely non-obvious to a person having only normal skill in the art. First, it is necessary to add a sufficient amount of spontaneous radioactive triggering atoms, such as thorium or depleted uranium, into the non-radioactive palladium host metal that is electrochemically loaded to contain high concentrations of deuterium. These triggering source atoms should not be viewed as contaminants but as necessary triggers to initiate a chain reaction given by Equation (1a) and to restart this reaction, as necessary, if it dies out for any reason. Even though some researches who observed measurable excess heat generation may have inadvertently introduced low levels of triggering atoms into the palladium that they used, possibly during reprocessing of their palladium metal, the performances of their electrolytic cells were still erratic, indicating that they had not added a sufficient amount of triggering material to promptly initiate a reaction after the palladium material was sufficiently well charged with deuterium.

In analogy with the operation of a conventional uranium fusion reactor by moving control rods into and out of the reactor core, the power level generated in a palladium fusion reactor could be increased or decreased by varying the electrical drive current that is responsible for setting the deuterium concentration level in the palladium rod. Specifically, if the electrical current is reduced so that deuterium is consumed by the reaction in Equation (1a) at a rate greater than it is replenished; the excess power level will diminish. And conversely, if the electrical current is increased so that the deuterium concentration level increases, the excess power generated will also increase. Here one must keep in mind that a change in deuterium concentration in a palladium rod (or other shape) is governed by a diffusion process and that it is not instantaneously responsive to the electrical current.

The simple model, given above, can be used to explain a number of instances where huge anomalous bursts of excess power were occasionally observed from some electrolytic cells. These cells were presumably electrochemically charged with a sufficiently high concentration of deuterium that they were (in analogy with a fission reactor) in a ‘super-critical’ state. And they remained quiescent in that state until some triggering event caused a supercritical chain reaction that resulted in a large positive excursion of output power. However, the power excursion became self-limiting because ‘burning’ of deuterium by Equation (1a) reduced its concentration in the palladium rod and this, in turn, quenched the output power. Nevertheless, actual reported instances of run-away reactions were spectacular, including one that completely destroyed one of Pons and Fleischmann's rectors and left a hole several inches deep in the concrete floor beneath the reactor.

With the benefit of the present understanding of a triggered reaction process, it may become possible to design, construct, and operate a low energy fusion nuclear reactor apparatus that can be controlled to produce energy on demand This type of reactor would not require any substantial radiation shielding since no penetrating neutrons would be produced.

The basic reactor might take the form of a series of parallel palladium rods each surrounded by a helical coil of platinum wire (similar to the geometry that Pons and Fleischmann used—see FIG. 1). These rods could be located in a common reactor vessel containing heavy water (D₂O). The palladium rods could be separate or could be connected to a common negative terminal (cathode) of a variable direct current (DC) electrical current source while the platinum wires would be connected to the positive terminal (anode) of the current source. It would be important to have a spontaneous radioactive element disbursed within the palladium material with sufficient concentration to serve as a frequent triggering source to initiate the fusion reaction with little delay. Once initiated, the energetic reaction by-products from the nuclear reaction [see Equation (1) or (1a)] might sustain a chain reaction that would continue so long as the local concentration of D in the reaction region remained sufficiently high.

The concentration of the D in the palladium rods could be controlled by two mechanisms: (1) the flow of electrical current between the platinum anodes and the palladium cathodes, and (2) the average ambient temperature of the palladium rods. Generally, the higher the temperature of the rods, the more likely that D will tend to out-diffuse and thereby reduce its concentration.

When operating such a fusion reactor, excess heat produced could be removed from the reactor by various well known means such as circulating heavy water, heated in a vessel containing the reactor, to a heat exchanger and then returning the cooled heavy water coming out of the heat exchanger back into the reactor vessel. Such a cooling system would be similar to those used in pressurized water fission reactors. In fact, it would be almost identical to the cooling system used in pressurized water reactors developed in Canada under the CANDU reactor program that use heavy water (D₂O) rather than naturally occurring water that is mostly comprised of the light atomic weight hydrogen nuclei (¹H).

A fusion reactor as described, above, would require a gas venting system to eliminate hydrogen gas (D₂) and oxygen gas (O₂) that would tend to build up due to the electrolytic chemical reaction during ‘charging’ of the palladium rods. Without proper venting, these gasses could reach explosive proportions.

The potential danger from such a chemical explosion should not be ignored. An actual explosion occurred at SRI International in one of their test reactors. This disaster was reported in the L.A. Times by science writer Lee Dye in his Jan. 2, 1992 article titled “Scientist Killed, 3 Hurt in Explosion at Research Facility”.

An alternative reactor core geometry that may be more advantageous than palladium rods would use closely spaced parallel plates of palladium separated by platinum, or some other metal, wire screens or grids. The space between the plates would be similar to the space between uranium fuel plates in many modern uranium fission reactors. This geometry would be helpful because the technology and computer codes to model the heat transfer from the plates to the water coolant are well developed and could be adapted for a fusion reactor.

There is one other important design feature that must be accommodated in a nuclear reactor such as the type described, above, using palladium plates that is not normally encountered in fission reactors. As the palladium is ‘charged’ with a high concentration of deuterium by electrochemical means to produce a palladium-hydride compound, the size of the palladium-hydride host material is known to expand up to approximately 15% by volume (relative to pure palladium). So, it will be important to ensure that the plates of palladium hydride (palladium containing hydrogen ions such as deuterium) or some related metal hydride (or rods, if used) have sufficient room and low force holding constraints so that expansion can occur without buckling or other undesired distortion.

It should also be mentioned that hydrogen ions can be concentrated in many different metals besides palladium using either electrochemical methods, as Pons and Fleischman did, or by other techniques such as soaking the metals in high pressure hydrogen gas. These methods are being investigated rather thoroughly for the storage and delivery of hydrogen gas to be used in conventional chemical combustion with oxygen from the atmosphere to power vehicles such as cars and trucks. The motivation for this work is to avoid transporting hydrogen in compressed gas cylinders that might set off a serious explosion if the vehicle were involved in an accident and one of more cylinders failed. There would be no possibility that a metal bock containing dissolved hydrogen could become explosive. But, the hydrogen in such a block could be converted into a gas, as needed, to propel the vehicle by applying heat to the metal bock causing the hydrogen to ‘out-gas’.

Thus, there are many potential metals and techniques for concentrating hydrogen (including deuterium) in a metal's atomic structure that are candidates for use in low energy nuclear reactors. They must be carefully evaluated to determine the optimum combination to produce clean nuclear power by the methods discussed in this patent application. But in all cases, a reliable and frequent triggering source will be required.

### BRIEF DESCRIPTION OF THE DRAWINGS

The above SUMMARY OF THE INVENTION as well as other features and advantages of the present invention will be more fully appreciated by reference to the following detailed descriptions of illustrative embodiments in accordance with the present invention when taken in conjunction with the accompanying drawings, wherein:

FIG. 1 is a sketch of the reactor used by Pons and Fleischmann in their original research.

FIG. 2 shows a series of low energy nuclear reactions (LENR) of deuterium that can be viewed as a chain reaction.

FIG. 3 shows a possible structure for a low energy fusion reactor.

### DETAILED DESCRIPTION OF THE DRAWINGS

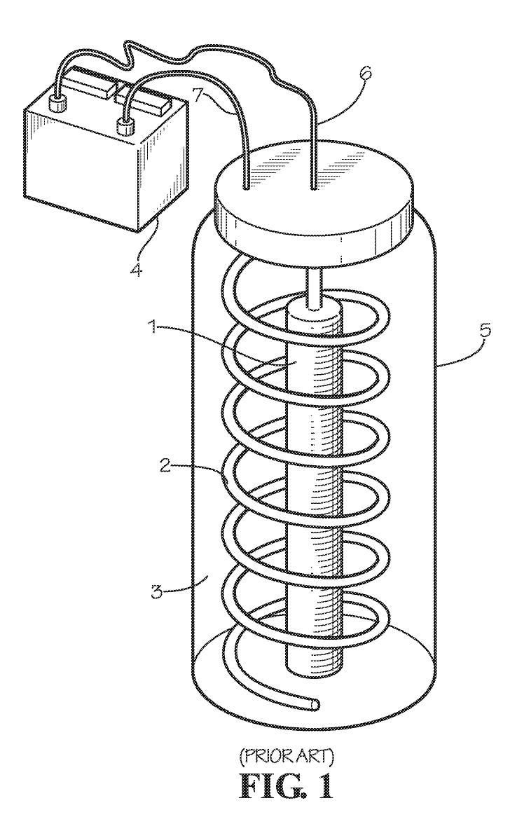

FIG. 1 is a sketch of the reactor used by Pons and Fleischmann in their original research that was desdribed in the Apr. 17, 1989 issue of TIME Magazine (less than one month after Pons and Fleischmann's initial announcement made in a press conference held on Mar. 23, 1989). The caption on this figure was “ENERGY FROM A JAR?”. The jar 5 is filled with heavy water (D₂O) 3 and contains a palladium cathode 1 and a platinum anode 2 that are connected by wires 6 and 7, respectively, to a battery 4. The palladium cathode 1 is said to be the size of a pencil and the heavy water has some added lithium hydroxide to improve its electrical conductivity.

The accompanying article written by Philip Elmer-DeWitt went on to say:

“The researchers . . . constructed an apparatus similar to that used by ninth-grade science students to split water into hydrogen and oxygen. Instead of ordinary H₂O, however, they used deuterium-rich heavy water (D₂O). The scientists tried an array of exotic elements for their electrodes, including palladium, a semi-precious metal known to absorb large numbers of hydrogen—and deuterium—atoms. Plunged into a bath of heavy water and charged by a twelve-volt battery, a palladium rod will draw a swarm of deuterium ions out of the liquid and into its lattice-like crystal structure. There the ions lodge and gather in such concentrations that they supposedly overcome their natural repulsion and fuse. Just how that happens . . . [no one can say].

The startling claim by Pons and Fleischmann was that for every watt they pumped into their crude fuel cell, more than four watts came out. . . . . It could be decades before the commercial potential of the process, if any, is determined ”

Philip Elmer-DeWitt's comment in the last sentence of his article, above, was very prophetic. Now, twenty-six years later, the commercial potential of the process is still undetermined. More than a thousand scientific papers have been written about this and related processes by researchers from all parts of the globe. And although numerous attempts have been made to repeat Pons and Fleischmann's world shaking experiment, they have met mostly with failure or only limited success and never with any assurance of reproducibility. The underlying physics remains unclear to the broad scientific community—that continues to lean towards skepticism.

Against this backdrop, the present inventor believes that the subject matter disclosed in this patent application may be helpful in providing clarity and direction for future generations.

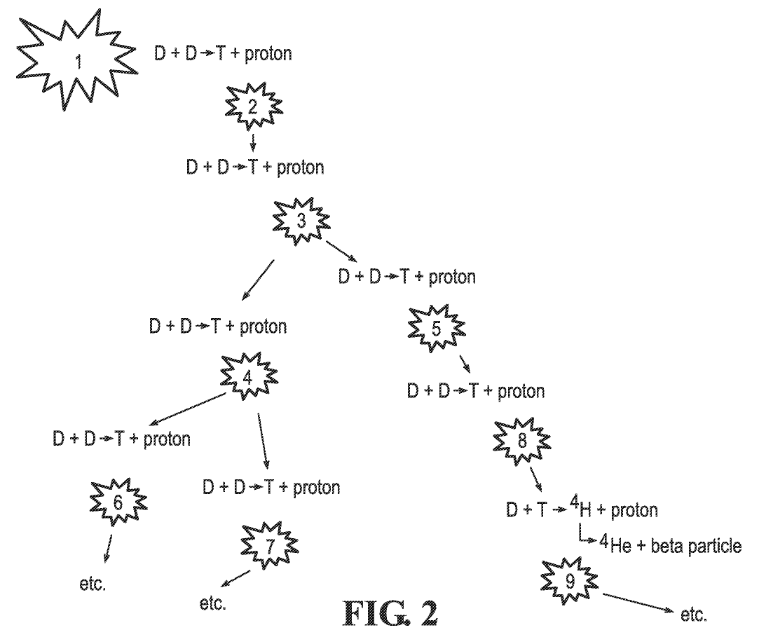

FIG. 2 shows a series of low energy nuclear reactions that may occur in the cathode of the Pons/Fleischmann reactor shown in FIG. 1 that has been loaded with deuterium (D). This series of reactions is triggered by a cosmic ray or the spontaneous emission of an alpha particle that produces a thermal spike depicted by a star burst 1. Subsequent induced reactions in the cathode following either Equation (1a) [i.e. D+D→T+proton] or Equations (3) and (4) [i.e. D+T→⁴H+proton, followed by ⁴H→⁴He+beta particle] also produce thermal spikes depicted as star bursts 2 through 9. The 4.0 MeV energy given off by the reaction in Equation (1a) is equal to the sum of the kinetic energies of the T (tritium ion) and proton (p) reaction by-products. These reaction by-products quickly lose their kinetic energy within a localized region in the cathode and thereby create the associated thermal spikes shown conceptually in this drawing as additional star bursts. Such a chain reaction may continue well beyond the physical extent of FIG. 2 and thereby explain some or all of the energy observed by Pons and Fleischmann when they operated their reactor.

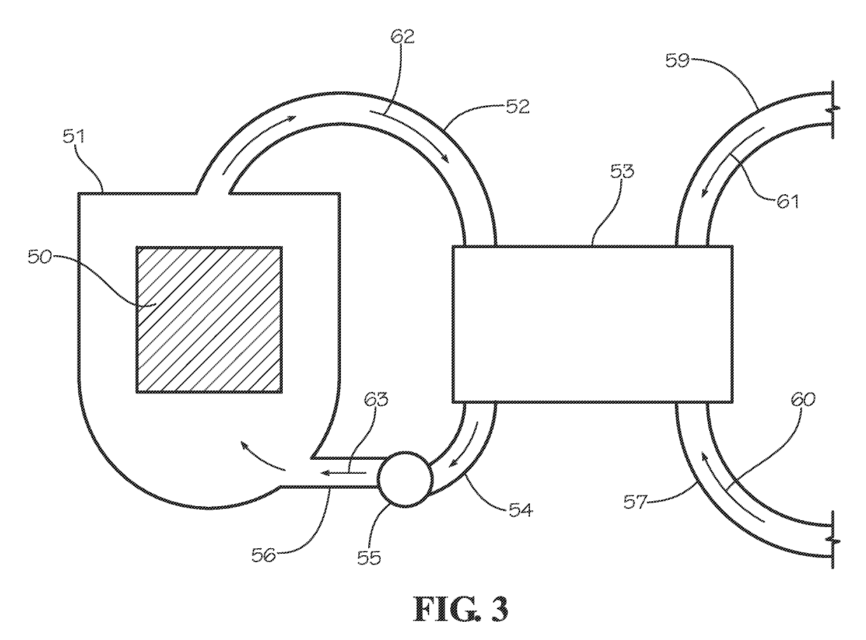

FIG. 3 shows a possible structure for a low energy fusion reactor. The heat producing core 50, comprised of rods or plates of palladium or some other metal alloy, such as titanium or nickel, that can absorb large concentrations of deuterium nuclei, is shown inside of a reactor vessel 51 that is connected by pipes 52, 54, and 56 to a heat exchanger 53. Heavy water, not shown, is circulated through the core 50 from the bottom to its top and through the pipes 52, 54, and 56 following the direction of flow arrows 62 and 63. An optional pump 55 may be employed to assist the circulation of the heavy water. Alternatively, circulation may occur by ‘natural circulation’ with the heated heavy water in the core 50 naturally rising vertically due to its lower density and flowing out through pipe 52. After being cooled by the heat exchanger 53, the heavy water will ‘sink’ out of the heat exchanger and flow into the bottom of the reactor vessel 51 through pipes 54 and 56. The main function of the heat exchanger 53 is to isolate the expensive heavy water used to cool the core 50 from normal water that can that can be circulated through pipes 57 and 59 in the direction of arrows 60 and 61 to perform some useful function such as generating electricity by conventional means.

In operation, the rods or plates of palladium or other suitable metal in the core 50 would be connected to the cathode of a direct current electrical source, not shown, and the anode of this source, not shown, would be connected to series of wires or a wire mesh (screen) or grid structure, not shown, also immersed in the heavy water, to control the concentration level of deuterium nuclei in the palladium or other material used to make the metal rods or plates. The rods or plates would include a dispersed low level concentration of suitable spontaneous alpha particle emitting material to ensure that a possible low energy nuclear reaction would be frequently triggered, approximately once per second per cubic centimeter of core material. Lower or higher concentrations of triggering material may also be satisfactory ranging from 1 trigger emission per cubic centimeter per minute to approximately 1000 triggering emissions per second. Trigger concentrations lower than this range would take too long to initiate a chain reaction as depicted in FIG. 2 and trigger concentrations above this range would not be necessary and might negatively impact the crystalline structure or the effectivity of the palladium or other host material.

While the above disclosure describes certain specific aspects of producing energy from low energy nuclear reactions, it should be understood that the scope of this invention is broader than specifically described in the specification and following claims and that the apparatuses and methods described herein relate broadly to producing energy from low energy nuclear reactions.

### Perspective

The inventor is well aware that the subject matter in a patent application must be ‘useful’ and satisfy the requirement of utility. Further, as stated by the U.S. Patent & Trademark Office, “the term ‘useful’ in this connection refers to the condition that the subject matter has a useful purpose and also includes operativeness, that is, a machine which will not operate to perform the intended purpose would not be called useful, and therefor would not be granted a patent”.

In this regard, the inventor makes no claim that the subject matter in this patent application will solve or mitigate the present or future energy problems facing humanity Nor does the inventor represent that the subject matter in this patent application can be used to produce any commercially useful amounts of energy. Rather, the subject matter is “useful” for two reasons, (1) it would be generally agreed by persons of normal skill in nuclear arts and also based on the teachings of conventional physics that purposely triggering a LENR by employing the subject matter in this patent application would enhance the reaction rate (thereby making the subject matter operative)—even though the magnitude of the enhancement is not presently known, and (2) the subject matter is expected to contribute to a better understanding of the LENR process that will likely continue to be explored by researchers throughout the world for years to come. In this regard, the availability and use of spontaneous alpha particle emitting metal alloys, encouraged by this invention, should be useful in advancing the understanding of LENRs and may also lead to possible future commercial applications. These factors are considered to be more than sufficient to satisfy the criteria of utility.

The invention claimed is:

1. A metal alloy comprised of a base metal host and a second metal that spontaneously emits alpha particles;
wherein the base metal host is comprised of pure palladium, titanium, nickel or any combination of these metals in any proportions;
wherein the said second metal is comprised of radium, thorium, depleted uranium, or any other metal isotope that spontaneously emits alpha particles in any proportions; and
wherein the concentration(s) of radium, thorium, depleted uranium, or any other metal isotope that spontaneously emits alpha particles is(are) adjusted to produce on average at least one spontaneous alpha particle emission per cubic centimeter of the metal alloy per minute.

2. An metal alloy comprised of a base metal host and a second metal that spontaneously emits alpha particles;
wherein the base metal host is comprised of pure palladium, titanium, nickel or any combination of these metals in any proportions;
wherein the said second metal is comprised of thorium, depleted uranium, or a combination of these two components in any proportions; and
wherein the concentration of thorium, depleted uranium, or any combination of these two metals is adjusted to produce on average between one and one thousand spontaneous alpha particle emission(s) per cubic centimeter of metal alloy per second.

3. A metal alloy as in claim 1 in which the said metal alloy is in the shape of a cylindrical rod or a multiplicity of cylindrical rods.

4. A metal alloy as in claim 1 in which the said metal alloy is in the shape of a flat plate or a multiplicity of flat plates.

5. An apparatus consisting of a single rod or multiplicity of rods as in claim 3 with each said rod or rods surrounded by a spiral shaped electrically conductive wire.

6. An apparatus consisting of a single flat plate or a multiplicity of flat plates as in claim 4 with said flat plates oriented parallel to each other and having flat electrically conductive wire meshes or grids adjacent to the outside broadest surfaces of a single flat plate or sandwiched between the broadest surfaces of a multiplicity of flat metal plates and, optionally, also adjacent to the outside broadest surfaces of the end flat plates in a structure consisting of a multiplicity of flat plates.

7. An apparatus as in claim 5 in which the said metal rods and spiral electrically conducting wire(s) do not make direct physical or electrical contact.

8. An apparatus as in claim 6 in which the said flat metal plate(s) and flat metal wire meshes or grids do not make direct physical or electrical contact.

9. An apparatus as in claim 7 that is immersed in heavy water (D₂O).

10. An apparatus as in claim 8 that is immersed in heavy water (D₂O).

11. An apparatus as in claim 9 having a direct current (DC) electrical current source with its cathode connected to the metal alloy rod(s) and the anode connected to the wire(s) surrounding the rod(s).

12. An apparatus as in claim 10 having a direct current (DC) electrical current source with its cathode connected to the metal alloy plates(s) and the anode connected to the wire mesh(es) or grid(s) surrounding the plate(s).

13. An apparatus as in claim 11 in which the said heavy water is circulated through a heat exchanger to remove heat that is produced in the metal rod(s) and transferred to the heavy water.

14. An apparatus as in claim 12 in which the said heavy water is circulated through a heat exchanger to remove heat that is produced in the flat metal plate(s) and transferred to the heavy water.

15. An apparatus consisting of metal alloy shaped rod or a multiplicity of rods as in claim 3 which is contained in a pressure vessel and bathed in high pressure deuterium gas.

16. An apparatus consisting of a flat metal alloy plate or a multiplicity of plates as in claim 4 which is contained in a pressure vessel and bathed in high pressure deuterium gas.

17. An apparatus comprised of a single flat plate or a multiplicity of flat plates of a metal alloy comprised of a base metal host and a second metal that spontaneously emits alpha particles;
wherein the base metal host is comprised of pure palladium, titanium, nickel or any combination of these metals in any proportions;
wherein the said second metal is comprised of thorium, depleted uranium, or a combination of these two components in any proportions;
wherein the concentration of thorium, depleted uranium, or any combination of these two metals is adjusted to produce on average between one and one thousand spontaneous alpha particle emission(s) per cubic centimeter of metal alloy per second;
wherein the said flat plates are oriented parallel to each other and having flat electrically conductive wire meshes or grids adjacent to the outside broadest surfaces of a single flat plate or sandwiched between the broadest surfaces of a multiplicity of flat metal plates and, optionally, also 115 adjacent to the outside broadest surfaces of the end flat plates in a structure consisting of a multiplicity of flat plates;
wherein a direct current (DC) electrical current source is employed with its cathode connected to the metal alloy plates(s) and the anode connected to the wire meshes or grids adjacent to the plates(s).
wherein the flat metal alloy plate(s) and wire meshes or grids are immersed in heavy water (D₂O) contained in a vessel and the said heavy water is circulated through a heat exchanger to remove heat that is produced in the flat metal plate(s) and transferred to the heavy water.
